(19) United States
(12) Patent Application Publication
(10) Pub. No.: US 2007/0073567 A1
(43) Pub. Date: Mar. 29, 2007

(54) Technique for building customizable process flows rapidly

(76) Inventor: Jogeswar Challapalli, Austin, TX (US)

Correspondence Address: IBM CORP (YA);C/O YEE & ASSOCIATES PC, P.O. BOX 802333, DALLAS, TX, 75380, US

(21) Appl. No.: 11/239,598

(22) Filed: Sep. 29, 2005

(51) Int. Cl. G06F 9/46

(52) U.S. Cl. 705/8

(57) ABSTRACT

A tool is provided for developing a service process with separate service components and wiring logic. The development tool allows a developer to develop a plurality of service components, wherein each service component in the plurality of service components has generic inputs and outputs, and to deploy the plurality of service components to a runtime environment. The development allows a developer to develop a wiring logic application, wherein the wiring logic application includes connectivity and decision logic with respect to the plurality of service components and to deploy the wiring logic application, separate from the plurality of service components, to the runtime environment.

### BACKGROUND OF THE INVENTION

1. Field of the Invention

The present invention relates to data processing and, in particular, to building customizable process flows. Still more particularly, the present invention provides a mechanism for developing and deploying process flows independently from process services.

2. Description of the Related Art

Business analysts, as well as line-of-business managers, are often responsible for designing and developing new business process models, or adapting existing models, to improve how their companies do business. With process models in place, a well-defined interface is established to identify and transform business processes into service-oriented applications.

Business process modeling tools enable business analysts to model, simulate, and analyze complex business processes quickly and effectively. The term “business process” does not necessarily imply that a business practice is performed. A “business process” is a service process that provides some service for a requesting application, a user, or a customer. For example, a business process may perform machine translation, digital certificate authentication, alphabetic or numeric sorting, or any other useful function.

Business process modeling tools:
provide comprehensive, user-friendly business process modeling and collaboration tools to graphically model processes across people, partners, and applications;
allow companies to quickly redesign processes as business needs change;
support multiple modeling methodologies and industry standards;
simulate and validate modeled processes and provides key performance metrics; and,
provide a team environment to share and maintain versions of models.

Many business processes can be very complex and modeling of the business processes is often restricted by the tools that allow the modeling of these processes. Some current visual tools, such as IBM Rational Rose, WBI (Web Intermediaries) Modeler, and Microsoft Visio®, go beyond the basic flowchart for a computer program and allow the modeling of processes.

As business processes are considered executables, there is a need to “wire” together these executables to work together. This wiring may be achieved in several different ways. One solution is to develop the processes with rule-based execution, which does not provide clean data flow and transformation techniques. Another solution is to use deductive programming; however, the applicability of deductive programming to the process domain is limited or not very clear. Yet another solution is to use complex programming constructs; however, it is difficult to integrate processes that do not adhere to any standards.

Several companies agree on the use of business process execution language (BPEL) as the standard meta-language for modeling business processes. The use of BPEL results in executable code being generated. However, even using BPEL to wire processes together, the executable code is deployed as a set of sub processes that are specifically programmed to work together. BPEL by itself does not provide much flexibility in modifying process flows.

### SUMMARY OF THE INVENTION

The present invention recognizes the disadvantages of the prior art and provides a tool for providing a service process with separate service components and wiring logic. The tool allows a developer to provide a plurality of service components, wherein each service component in the plurality of service components has generic inputs and outputs, and to deploy the plurality of service components to a runtime environment. The tool allows a developer to provide a wiring logic application, wherein the wiring logic application creates one or more wiring logic components that provide connectivity and decision logic with respect to the plurality of service components. The runtime environment then executes the plurality of service components and the wiring logic application, wherein the wiring logic components remain separate from the plurality of service components in the runtime environment.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which aspects of the present invention may be implemented;

FIG. 2 is a block diagram of a data processing system in which aspects of the present invention may be implemented;

FIG. 3 is a block diagram illustrating an example of an order processing business process in accordance with exemplary aspects of the present invention;

FIGS. 4A and 4B are block diagrams illustrating an example of an order processing business process and customization in accordance with exemplary aspects of the present invention;

FIG. 5 is a block diagram illustrating a development environment in accordance with exemplary aspects of the present invention;

FIG. 6 depicts an illustrative user interface for a wiring logic development tool in accordance with exemplary aspects of the present invention;

FIG. 7 is a flowchart illustrating the operation of developing a service process with separate service components and wiring logic in accordance with exemplary aspects of the present invention; and

FIG. 8 is a flowchart illustrating the operation of deployment of a service process at a customer computer with separate service components and wiring logic in accordance with exemplary aspects of the present invention.

### DETAILED DESCRIPTION OF THE PREFERRED EMBODIMENT

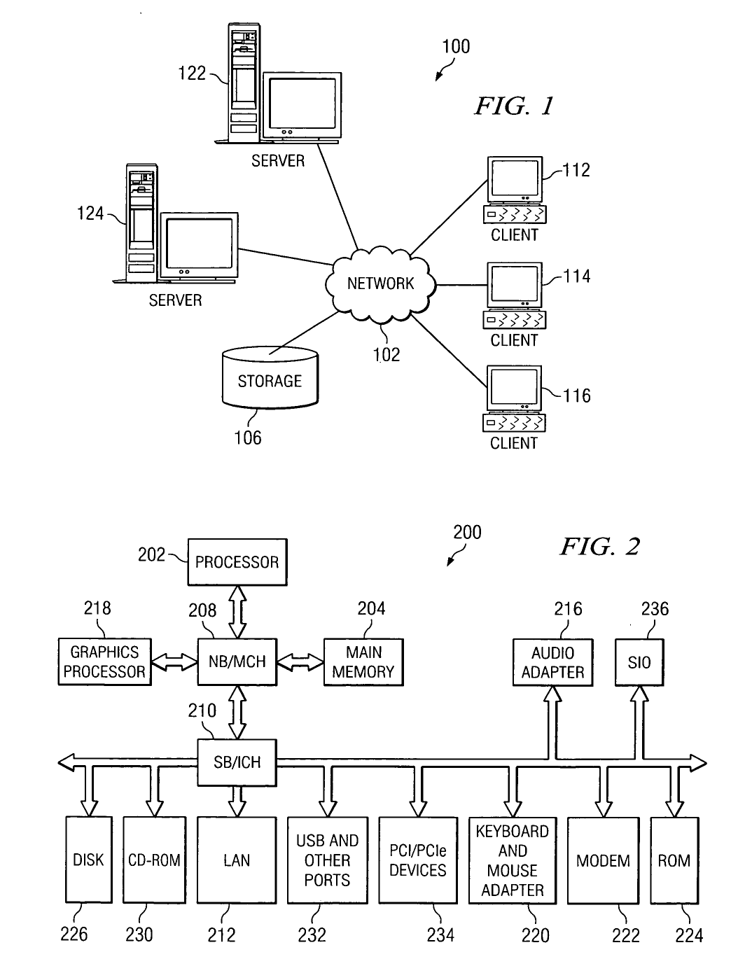

The present invention provides for development and deployment of process flows independent from the development and deployment of the process service components. FIGS. 1 and 2 are provided as exemplary diagrams of data processing environments in which embodiments of the present invention may be implemented. It should be appreciated that FIGS. 1 and 2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 122 and server 124 connect to network 102 along with storage unit 106. In addition, clients 112, 114, and 116 connect to network 102. These clients 112, 114, and 116 may be, for example, personal computers or network computers. In the depicted example, server 122 provides applications to clients 112, 114, and 116. Clients 112, 114, and 116 are clients to server 122 in this example. Network data processing system 100 may include additional servers, clients, and other devices not shown.

More particularly, server 122 may provide business processes to clients 112, 114, and 116. These business processes may be deployed as service components, which are applications that run within a specific runtime environment running on server 122. Such a runtime environment may be, for example, a Java virtual machine (JVM™), Microsoft .NET™, IBM Service-Oriented Architecture (SOA), or the like.

In accordance with exemplary aspects of the present invention, a tool is provided that allows a developer to develop the wiring of service components separate from the development of the service components themselves. The tool may be an application that runs on a client, such as client 112. The wiring may then be generated as an executable language, which is then deployed to and compiled into the runtime environment of server 122.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1 and 2 and the above-described examples are not meant to imply architectural limitations. For example, data processing system 200 also may be a tablet computer, laptop computer, or telephone device in addition to taking the form of a PDA.

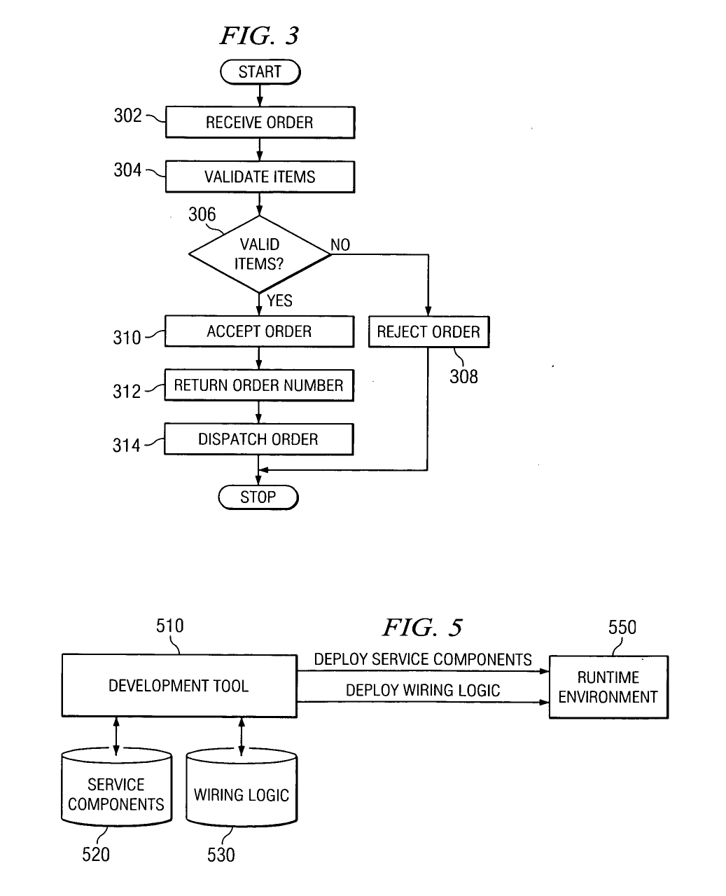

FIG. 3 is a block diagram illustrating an example of an order processing business process in accordance with exemplary aspects of the present invention. The business process is made up of service components, which are software components that provide a given function. Distributed object component technology has evolved to provide a solid foundation for modern business application design in online transaction processing systems. These component technologies include, for example, the use of the Java™ programming language, the Java™ 2 enterprise edition (J2EE) programming model, and component technologies, such as Java™ server pages (JSPs), servlets, and portlets for online presentation logic. Component technologies also include, for example, service-oriented architecture (SOA), which is an architecture that allows loose coupling and reuse of software components.

These component models are expressly designed to enable a strong separation of concerns between business application logic and the underlying information systems technology on which those application components are hosted. This separation enables application developers to focus on domain knowledge, adding value to their business, and to avoid the intricacies of distributed information systems technology. Further, these component models enable declarative approaches to enforcing security, the relationships between objects, internationalization, serviceability, and persistence, essentially virtualizing the relationship of the business application component to its underlying information system.

In this example, the service components, also referred to as software components or process components, include, for example, receive order component 302, validate items component 304, reject order component 308, accept order component 310, return order number component 312, and dispatch order component 314. These components are “wired” to form the overall business logic. The term “business logic” or “business process” is not intended to imply that a business practice is performed. A “business process,” as well as its “business logic,” is a service process that provides some service for a requesting application, a user, or a customer. For example, a business process may perform machine translation, digital certificate authentication, alphabetic or numeric sorting, or any other useful function.

In the example illustrated in FIG. 3, these service components are be “wired” such that operation starts with receive order component 302 and that operation proceeds to validate items component 304. Then, a determination is made as to whether the items are valid in decision logic 306. If the items are not valid in decision logic 306, then operation passes to reject order component 308 and operation then stops. If, however, the items are valid in decision logic 306, then operation passes to accept order logic component 310, operation passes to return order number component 312, then operation passes to dispatch order component 314, and operation stops.

The wiring of these service components may be accomplished in several different ways. One solution is to develop the processes with rule-based execution, which does not provide clean data flow and transformation techniques. Another solution is to use deductive programming; however, the applicability of deductive programming to the process domain is limited or not very clear. Yet another solution is to use complex programming constructs; however, it is difficult to integrate processes that do not adhere to any standards.

Several companies agree on the use of business process execution language (BPEL) as the standard meta-language for modeling business processes. BPEL is an extensible markup language (XML) based language for defining Web services business processes. BPEL provides both an abstract level and a low level. At the abstract level, BPEL is used to define broader parameters and constraints while keeping details hidden. At the low level, BPEL defines executable processes.

The use of BPEL results in executable code being generated. However, even using BPEL to wire service components together, the executable code is deployed as a set of service components that are specifically programmed to work together. BPEL by itself does not provide much flexibility in modifying business process flows. In other words, the data flow is currently developed as part of the service components themselves. For example, in current development environments, decision logic 306 will most likely be developed as part of validate items component 304.

In accordance with exemplary aspects of the present invention, the service components are developed and provided to the end user or systems integrator who understands the customer's needs with the necessary descriptions. These service components are developed and deployed separate from the wiring algorithms. In other words, the service components are designed with general constraints on inputs and outputs, but no specific connectivity with respect to other service components.

According to exemplary aspects of the present invention, a tool is provided to design the wiring diagrams as the connection algorithms. This “wiring” is the business process execution logic, which is separate from the service components themselves. The tool generates a wiring logic, which may be in an executable language that may be deployed separately to the runtime environment. The wiring logic is then compiled into the runtime environment, which allows the service components to be integrated easily and rapidly.

In one exemplary embodiment, the wiring description is generated as a business process execution language (BPEL) file. The BPEL file identifies the service components and provides the logic that allows the service components to execute together to form the overall business logic. Since BPEL is executable, the customized flow may be deployed separately to execute in the runtime environment to help the business customer.

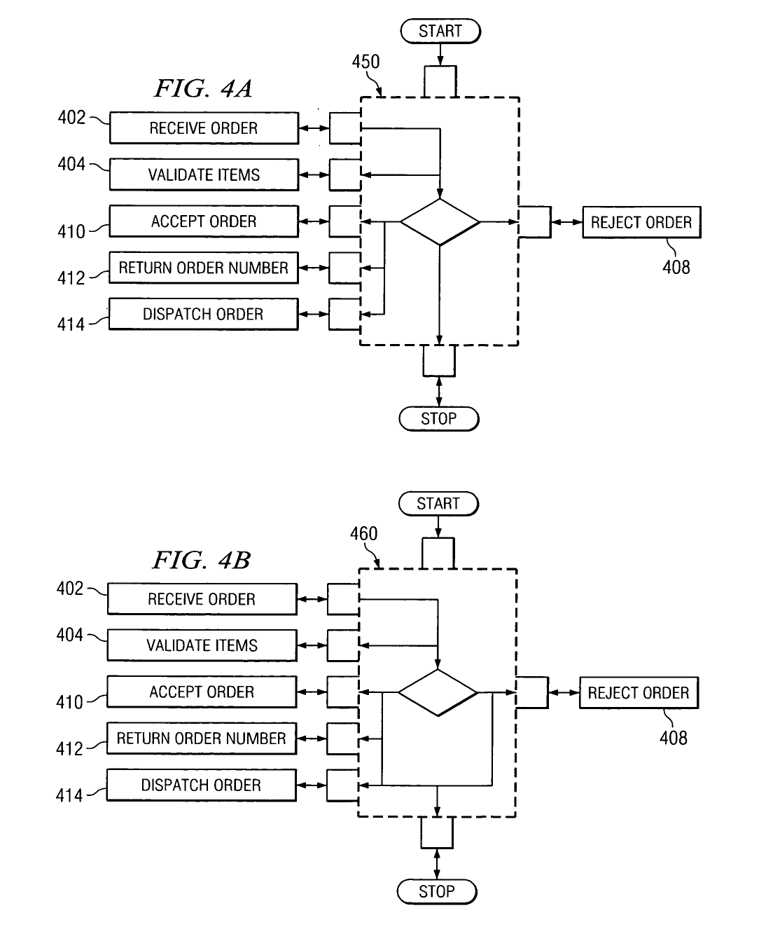

FIGS. 4A and 4B are block diagrams illustrating an example of an order processing business process and customization in accordance with exemplary aspects of the present invention. In this example illustrated in FIG. 4A, the service components include, for example, receive order component 402, validate items component 404, reject order component 408, accept order component 410, return order number component 412, and dispatch order component 414. These components are “wired” to form the overall business logic.

Service components 402-414 are developed and deployed separate from the wiring algorithms and are designed with general constraints on inputs and outputs, but no specific connectivity with respect to other service components. As such, service components 402-414 may be deployed to the customer as Java™ archive (JAR) files. The service components may then be extracted and compiled into the runtime environment of the customer.

A systems integrator may then develop wiring logic 450 separately using a development tool. Wiring logic 450 describes the connectivity and process flow through the overall business process. Wiring logic 450 may be generated as a BPEL file, which may be deployed to the customer's runtime environment separately.

In the example illustrated in FIG. 4B, the system integrator may modify the wiring logic to form wiring logic 460. In this way, the wiring of the business process may be modified without making any modifications to the service components themselves. There is no need to re-deploy the service components. Rather, the wiring logic may be generated as a modified BPEL file, for example, which may then be re-deployed to the customer's runtime environment. This modified BPEL file may then be compiled into the runtime environment. As a result, the same service components may be used and re-used in many different configurations by simply changing the wiring logic.

FIG. 5 is a block diagram illustrating a development environment in accordance with exemplary aspects of the present invention. Development tool 510 provides software development tools for programming a service process. Development tool 510 may be a full integrated development environment (IDE), which is a set of programs run from a single user interface. For example, programming languages often include a text editor, compiler, and debugger, which are all activated from and function from a common graphical user interface. Development tool 510 may include tools for developing service components 520, as well as tools for developing wiring logic 530.

In one embodiment, the tools for developing wiring logic may be provided as a plug-in to an existing IDE. Further, the IDE may be modified to assist developers in developing service components with general inputs and outputs without specific connectivity or decision logic with respect to other service components. Alternatively, development tool 510 may include one tool for developing software components 520 and a separate tool for developing wiring logic 530.

Development tool 510 deploys service components 520 to runtime environment 550. Runtime environment 550 may be the runtime of a customer's server, for example. Development tool 510 also deploys wiring logic 530 to runtime environment 550. Service components 520 may be deployed as JAR files. Service components 520 may generally be developed by the software vendor and may even be developed by multiple different vendors.

As described above, in an exemplary embodiment, development tool 510 may export wiring logic 530 as a BPEL file. The BPEL file may then be compiled into runtime environment 550. When the BPEL is modified, the a DeployBPEL command line tool within development tool 510 is the only tool necessary to deploy the BPEL file to the runtime environment of the customer, thus generating a new service process.

Service components 520 are included in the class path of the deployed wiring logic application, such as wiring logic 530. When the service components and the wiring logic are deployed, the application now runs as a complete service process. If a new wiring logic file is produced by modifying the flow using development tool 510, a new service process may be generated simply by re-deploying wiring logic 530.

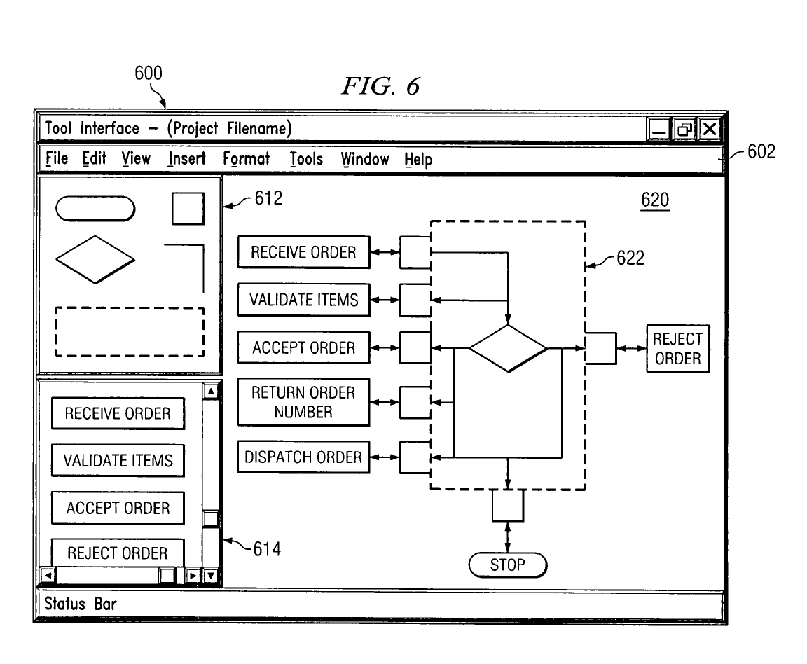

FIG. 6 depicts an illustrative user interface for a wiring logic development tool in accordance with exemplary aspects of the present invention. Tool interface window 600 includes a wiring logic element display portion 612 and a service component display portion 614. The wiring logic may be graphically designed and functionally developed in display area 620.

In an exemplary implementation of a wiring logic development tool interface, service components may be selected from display portion 614 and placed into display area 620. Wiring logic may then be developed graphically in block 622 in display area 620. Service components may then be connected, through generally defined inputs and outputs to block 622. Connections, decision logic, and the like may be defined using wiring logic elements from display portion 612.

Commands and other actions may be activated using menu 602. For example, the “Tools” menu may provide a DeployBPEL command tool, as described above. The example wiring logic development tool interface shown in FIG. 6 is only exemplary and is not intended to assert or imply any limitation with regard to the environments in which aspects or embodiments of the present invention may be implemented. Many modifications to the development tools may be made without departing from the spirit and scope of the present invention.

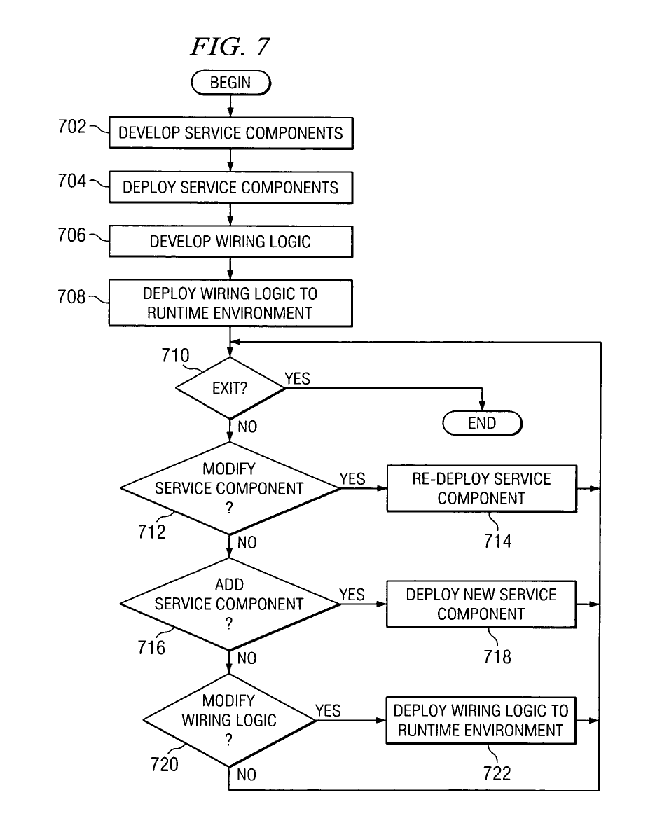

FIG. 7 is a flowchart illustrating the operation of developing a service process with separate service components and wiring logic in accordance with exemplary aspects of the present invention. Operation begins and one or more software vendors develop service components with generic inputs and outputs (block 702). The service components are then deployed to the runtime environment (block 704). Then, a systems integrator develops wiring logic for the service process (block 706) and deploys the wiring logic to the runtime environment (block 708).

Thereafter, the development tool determines whether an exit condition exists (block 710). An exit condition may exist, for example, if a user closes the development tool. If an exit condition exists, then operation ends.

However, if an exit condition does not exist in block 710, the development tool determines whether a modified service component is developed (block 712). If a modified service component is developed, the service component is re-deployed (block 714). Thereafter, operation returns to block 710 to determine whether an exit condition exists.

If a modified service component is not developed in block 712, the development tool determines whether a new service component is added (block 716). If a new service component is added, the development tool deploys the new service component (block 718). Thereafter, operation returns to block 710 to determine whether an exit condition exists.

If a new service component is not added in block 716, the development tool determines whether the wiring logic is modified (block 720). If the wiring logic is modified, the development tool deploys the modified wiring logic to the runtime environment (block 722). Thereafter, operation returns to block 710 to determine whether an exit condition exists.

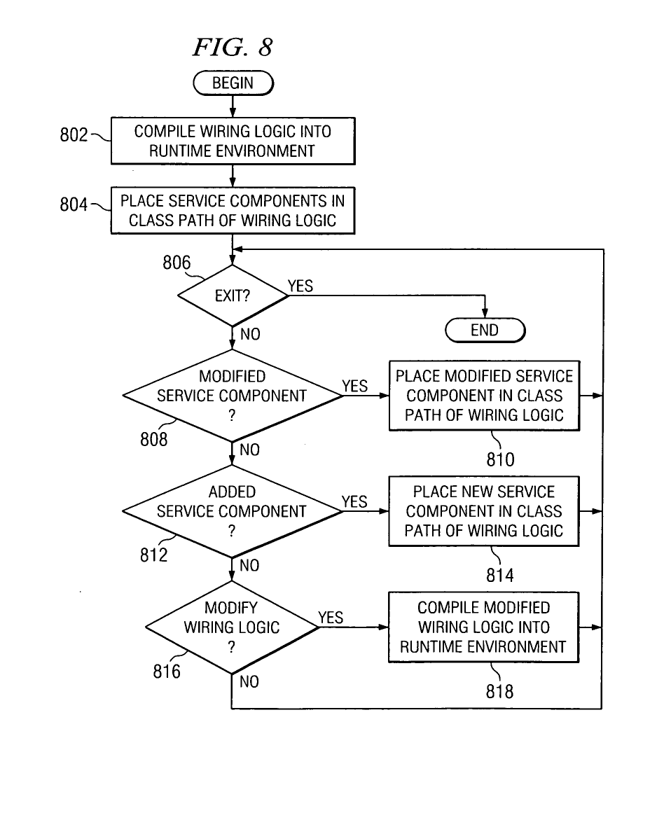

FIG. 8 is a flowchart illustrating the operation of deployment of a service process at a customer computer with separate service components and wiring logic in accordance with exemplary aspects of the present invention. Operation begins and the customer computer compiles the wiring logic into the runtime environment (block 802). The customer computer then places the service components in the class path of the wiring logic (block 804).

Thereafter, the customer endpoint computer determines whether an exit condition exists (block 806). An exit condition may exist, for example, if the customer computer is shut down. If an exit condition exists, then operation ends.

However, if an exit condition does not exist in block 806, the customer computer determines whether a modified service component is received (block 808). If a modified service component is received, the customer computer places the modified service component in the class path of the wiring logic (block 810). Thereafter, operation returns to block 806 to determine whether an exit condition exists.

If a modified service component is not received in block 808, the customer computer determines whether a new service component is added (block 812). If a new service component is added, the customer computer places the new service component in the class path of the wiring logic (block 814). Thereafter, operation returns to block 806 to determine whether an exit condition exists.

If a new service component is not added in block 812, the customer computer determines whether modified wiring logic is received (block 816). If modified wiring logic is received, the customer computer compiles the modified wiring logic into the runtime environment (block 818). Thereafter, operation returns to block 806 to determine whether an exit condition exists.

Thus, the exemplary aspects of the present invention overcome the disadvantages of the prior art by separating the service components from the connectivity and decision logic. The “wiring” logic is developed separately and exported as an executable file. The executable wiring logic file may then be separately deployed to the customer's runtime environment. In this way, pre-existing service components may be reconfigured rapidly and conveniently to form new service processes.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for executing a service process having separate service components and wiring logic components, the computer implemented method comprising:
providing a plurality of service components, wherein each service component in the plurality of service components has generic inputs and outputs;
providing a wiring logic application, wherein the wiring logic application creates one or more wiring logic components that provide connectivity and decision logic with respect to the plurality of service components when in a runtime environment; and
executing the plurality of service components and the one or more wiring logic components in the runtime environment, wherein the one or more wiring logic components remain separate from the plurality of service components in the runtime environment.

2. The computer implemented method of claim 1, wherein the plurality of service components and the wiring logic are deployed to the runtime environment separately.

3. The computer implemented method of claim 1, further comprising:
compiling the wiring logic application into the runtime environment.

4. The computer implemented method of claim 1, further comprising:
placing the plurality of service components in a class path of the one or more wiring logic components.

5. The computer implemented method of claim 1, further comprising:
modifying the wiring logic application to form a modified wiring logic application;
providing the modified wiring logic application to the runtime environment,
wherein the modified wiring logic application creates a new service process without re-deploying the service components.

6. The computer implemented method of claim 5, further comprising:
compiling the modified wiring logic application into the runtime environment.

7. The computer implemented method of claim 1, further comprising:
presenting a development tool graphical user interface for a development tool.

8. The computer implemented method of claim 7, wherein the development tool graphical user interface presents a wiring logic element display portion, a service component display portion, and a development display area.

9. The computer implemented method of claim 8, wherein the development tool graphical user interface enables an operator to place wiring logic elements from the wiring logic element display portion and service components from the service component display portion onto the development display area to form the wiring logic application graphically.

10. The computer implemented method of claim 7, wherein the development tool exports the wiring logic application.

11. A computer system for executing a service process with separate service components and wiring logic components, the computer system comprising:
a development workstation; and
a server, wherein the server has a runtime environment and wherein the server provides services to clients through applications running in the runtime environment,
wherein the server is configured to receive a plurality of service components, wherein each service component in the plurality of service components has generic inputs and outputs;
wherein the development workstation is configured to provide a wiring logic application, wherein the wiring logic application creates one or more wiring logic components that provide connectivity and decision logic with respect to the plurality of service components when in the runtime environment; and
wherein the server is configured to execute the plurality of service components and the one or more wiring logic components in the runtime environment, wherein the one or more wiring logic components remain separate from the plurality of service components in the runtime environment.

12. The computer system of claim 11, wherein the plurality of service components and the wiring logic application are deployed to the runtime environment separately.

13. The computer system of claim 11, wherein the server is configured to compile the wiring logic application into the runtime environment.

14. The computer system of claim 11, wherein the development workstation is configured to modify the wiring logic application to form a modified wiring logic application and provide the modified wiring logic application to the runtime environment, wherein the server compiles the modified wiring logic application into the runtime environment to create a new service process without re-deploying the service components.

15. A computer program product in a computer readable medium for integrating a service process having separate service components and wiring logic components, wherein a plurality of service components execute in a runtime environment, wherein each service component in the plurality of service components has generic inputs and outputs, the computer program product comprising:
a wiring logic application including instructions for creating one or more wiring logic components that provide connectivity and decision logic with respect to the plurality of service components; and
instructions for integrating the plurality of service components and the one or more wiring logic components in the runtime environment, wherein the one or more wiring logic components remain separate from the plurality of service components in the runtime environment.

16. The computer program product of claim 15, wherein the plurality of service components and the wiring logic application are deployed to the runtime environment separately.

17. The computer program product of claim 15, further comprising:
instructions for receiving a modified wiring logic application in the runtime environment; and
instructions for compiling the modified wiring logic application into the runtime environment to create a new service process without re-deploying the service components.
